(19) United States
(12) Patent Application Publication
(10) Pub. No.: US 2022/0144034 A1
(43) Pub. Date: May 12, 2022

(54) PULLING COMPENSATION APPARATUS FOR VEHICLE

(71) Applicant: Hyundaekangjeon Co., Ltd., Changwon-si (KR)

(72) Inventor: Yong Soo KIM, Changwon-si (KR)

(73) Assignee: Hyundaekangjeon Co., Ltd., Changwon-si (KR)

(21) Appl. No.: 17/097,414

(22) Filed: Nov. 13, 2020

(30) Foreign Application Priority Data
Nov. 9, 2020 (KR) 10-2020-0148949

(51) Int. Cl. B60G 17/016; B60R 16/023; B60G 17/015; B60G 17/019; H02K 7/102; H02K 7/116

(52) U.S. Cl. CPC B60G 17/016; B60G 2800/94; B60G 17/0157; B60G 17/01908; B60G 17/01933; H02K 7/102; H02K 7/116; B60G 2202/12; B60G 2204/419; B60G 2204/423; B60G 2400/05; B60G 2400/10; B60G 2400/25; B60G 2500/20; B60R 16/0231

(57) ABSTRACT

Disclosed is a pulling compensation apparatus for a vehicle including: a main body part capable of loading a power engine of the vehicle and goods or carrying people; a transfer part transferring the main body part; a sensor part sensing a height and a slope of the main body part, pulling due to motion inertia and an obstacle to transmit a signal; a controller embedded with a computer receiving the signal of the sensor part; and a pulling reduction part controlled by the controller to reduce the pulling and shocks of the main body part. The pulling reduction part varies the height to reduce the pulling and shocks of the main body part when the pulling of the main body part and the obstacle are sensed by the sensor part.

### CROSS-REFERENCE TO PRIOR APPLICATION

This application claims priority to Korean Patent Application No. 10-2020-0148949, (filed on Nov. 9, 2020), which is hereby incorporated by reference in its entirety.

### BACKGROUND

The present invention relates to a pulling compensation apparatus for a vehicle, and more particularly, to a pulling compensation apparatus for a vehicle so as to reduce a pulling phenomenon of a vehicle caused by pulling due to inertia, inclination of a vehicle body due to a slope, and inconvenience due to a difference in height of the ground while the vehicle is running and to adjust a height.

As most of the land consists of mountainous areas, many inclined roads are formed, and vehicles capable of responding to slopes are required. In addition, even in the case of a road that has been flattened, the risk that a rollover accident may occur due to a pulling phenomenon caused by a sudden turn and sudden stop of a vehicle has not been completely resolved.

For example, when describing the content disclosed in Korean Patent Registration No. 10-1413045 (Jun. 23, 2014), there is disclosed a wheelchair of which leveling is adjustable, including a frame on which rear wheels are mounted; a fixed chair fixed to the frame; a movable chair placed on the top of the fixed chair and having a seat plate; a leveling adjustment part for moving the seat plate from the fixed chair in order for the seat plate to be horizontal even if the slope of the ground is changed; and a fixing part to selectively fix the movable chair to the fixed chair.

However, in the related art, there is a limitation in continuously maintaining a leveling state even in a pulling phenomenon due to inertia caused by driving on a sharp curve or while driving on a slope, and as the weight of the vehicle increases, there is a problem in that a risk such as a rollover accident due to inertia is not prevented. In addition, it was difficult to pass through high irregularities formed on the ground, curved points, rather deep puddles, strong winds, etc. (hereinafter referred to as “difficulties”).

### SUMMARY

The present invention is derived to solve the problems of the prior art as described above. An object of the present invention is to pass through difficulties without turning over a vehicle by sensing a slope, pulling, and a height in vehicle body of the vehicle by a gyro sensor, an acceleration sensor and a height sensor and adjusting the height in vehicle body of the vehicle according to signals of the gyro sensor, the acceleration sensor, and the height sensor.

According to a preferred embodiment of the present invention, there is provided a pulling compensation apparatus for a vehicle including: a main body part capable of loading a power engine of the vehicle and goods or carrying people; a transfer part transferring the main body part; a sensor part sensing a height and a slope of the main body part, pulling due to motion inertia and an obstacle to transmit a signal; a controller embedded with a computer receiving the signal of the sensor part; and a pulling reduction part controlled by the controller to reduce the pulling and shocks of the main body part, wherein when the pulling of the main body part and the obstacle are sensed by the sensor part, the pulling reduction part varies the height to reduce the pulling and shocks of the main body part.

Further, there is provided a pulling compensation apparatus for a vehicle including: a main body part capable of loading a power engine of the vehicle and goods or carrying people; a transfer part transferring the main body part; a sensor part sensing a height and a slope of the main body part, pulling due to motion inertia and an obstacle to transmit a signal; a controller embedded with a computer receiving the signal of the sensor part; and a pulling reduction part controlled by the controller to reduce the pulling and shocks of the main body part, wherein the pulling reduction part includes a plurality of geared motors provided at a lower portion of the main body part; a buffer spring supporting and buffering the main body part; a partial rotation shaft that is connected to the geared motor and provided in a left-right direction of the main body part to be rotated in a front-rear direction of the main body part; a connection arm connected to the partial rotation shaft; and a twist spring provided between the geared motor and the partial rotation shaft, wherein when the pulling and the shocks of the main body part are sensed by the sensor part, the pulling reduction part varies the height to reduces the pulling of the main body part, and the twist spring transmits the power by the geared motor to the partial rotation shaft, and reduces a sudden load applied to the geared motor.

The pulling reduction part may include a plurality of geared motors provided on one side of the main body part; a plurality of connection arms connected to the other side of the main body part and provided to be rotated by the geared motors; and a buffer spring part provided between the main body part and the transfer part, wherein the buffer spring part may support the main body part and buffer the shocks applied to the main body part, and the connection arm may be rotated by the geared motor while supporting the main body part, so that the height of the pulling reduction part may be varied.

The geared motor may further include a twist spring provided on one side of the geared motor; and a partial rotation shaft connecting the twist spring and a connection arm, wherein the twist spring may transmit the power to the partial rotation shaft, and support the main body part while reducing the shocks transmitted from the partial rotation shaft.

Further, there is provided a pulling compensation apparatus for a vehicle including: a main body part capable of loading a power engine of the vehicle and goods or carrying people; a transfer part transferring the main body part; a sensor part sensing a height and a slope of the main body part, pulling due to motion inertia and an obstacle to transmit a signal; a controller embedded with a computer receiving the signal of the sensor part; and a pulling reduction part controlled by the controller to reduce the pulling and shocks of the main body part, wherein the pulling reduction part includes an outer pillar provided at the lower side of the main body part and having a receiving space therein; an inner pillar provided to be moved inside the outer pillar and having a rack; a buffer spring provided inside the outer pillar and the inner pillar; shock absorbers that support the main body part together with the buffer spring and are provided for a buffering action; and a geared motor provided on one side of the outer pillar and having a pinion gear provided to engage with the rack to lift the inner pillar, wherein when the pulling of the main body part and the obstacle are sensed by the sensor part, the pulling reduction part varies the height to reduce the pulling and shocks of the main body part.

The pulling compensation apparatus for the vehicle may further include a signal input part provided at one side of the main body part, wherein the signal input part may transmit a signal to the controller by a user's operation to selectively control the pulling reduction part.

The sensor part may include a plurality of height sensors that senses the height of the main body part; a gyro sensor that senses the inclination of the main body part; and an acceleration sensor that senses pulling due to motion inertia of the main body part.

The geared motor may include a twist spring provided on one side of the geared motor; and a partial rotation shaft connecting the twist spring and a pinion gear. The twist spring may transmit the power to the pinion gear, and support the main body part while reducing the shocks transmitted from the vehicle.

The geared motor may further include an electronic brake provided at a rear end of the geared motor, wherein the electronic brake may prevent the geared motor from being rotated by a load applied to the main body part and the transfer part.

By means of solving the above problems, the present invention has an effect of preventing discomfort and rollover accidents by reducing the pulling caused by motion inertia during stop and sudden rotation of a vehicle.

In addition, the present invention has an effect of increasing or lowering the height of a main body part or a pulling reduction part itself of the vehicle so as to easily pass through the difficulty area.

### BRIEF DESCRIPTION OF THE DRAWINGS

FIG. 1 is a diagram illustrating a state of a vehicle and goods while running on a horizontal road.

FIG. 2 is a diagram illustrating a state in which the vehicle of FIG. 1 is suddenly stopped and the goods are pulled to one side.

FIG. 3 is a rear view illustrating a state in which the vehicle provided with a pulling compensation apparatus of the present invention runs on a horizontal road.

FIG. 4 is a schematic view illustrating a state of a geared motor of the present invention.

FIG. 5 is a diagram illustrating a configuration diagram of the present invention.

FIG. 6 is a rear view illustrating a state in which the vehicle provided with the pulling compensation apparatus for the vehicle of the present invention suddenly turns to the right.

FIG. 7 is a rear view illustrating a state in which the vehicle provided with the pulling compensation apparatus for the vehicle of the present invention suddenly turns to the left.

FIG. 8 is a rear view illustrating a state in which a vehicle provided with a pulling compensation apparatus for a vehicle according to a second embodiment of the present invention runs on a horizontal road.

FIG. 9 is a rear view illustrating a state in which the vehicle provided with the pulling compensation apparatus for the vehicle according to the second embodiment of the present invention runs on a road inclined to the left.

FIG. 10 is a rear view illustrating a state in which the vehicle provided with the pulling compensation apparatus for the vehicle according to the second embodiment of the present invention runs on a road inclined to the right.

FIG. 11 is a rear view illustrating a state in which a vehicle provided with a pulling compensation apparatus for a vehicle according to a third embodiment of the present invention runs on a horizontal road.

FIG. 12 is a rear view illustrating a state in which the vehicle provided with the pulling compensation apparatus for the vehicle according to the third embodiment of the present invention suddenly turns to the left.

FIG. 13 is a rear view illustrating a state in which the vehicle provided with the pulling compensation apparatus for the vehicle according to the third embodiment of the present invention suddenly turns to the right.

FIG. 14 is a side view illustrating a state in which a vehicle provided with a pulling compensation apparatus for a vehicle according to a fourth embodiment of the present invention runs on a horizontal road.

FIG. 15 is a side view illustrating a state in which the vehicle provided with the pulling compensation apparatus for the vehicle according to the fourth embodiment of the present invention runs on a road inclined forward.

FIG. 16 is a side view illustrating a state in which the vehicle provided with the pulling compensation apparatus for the vehicle according to the fourth embodiment of the present invention runs on a road inclined backward.

FIG. 17 is a side view illustrating a state in which the vehicle provided with the pulling compensation apparatus for the vehicle according to the fourth embodiment of the present invention brakes suddenly while lifting a vehicle body.

FIG. 18 is a side view illustrating a side appearance of a vehicle provided with a pulling compensation apparatus for a vehicle according to a fifth embodiment of the present invention.

FIG. 19 is a side view illustrating a state in which a vehicle provided with a pulling compensation apparatus for a vehicle according to a sixth embodiment of the present invention runs on a horizontal road.

FIG. 20 is a side view illustrating a state in which the front of the vehicle provided with the pulling compensation apparatus for the vehicle according to the sixth embodiment of the present invention is lifted.

### DETAILED DESCRIPTION

Terms used in the present specification will be described in brief and the present invention will be described in detail.

Terms used in the present invention adopt general terms which are currently widely used as possible by considering functions in the present invention, but the terms may be changed depending on an intention of those skilled in the art, a precedent, emergence of new technology, etc. Accordingly, the term used in the present invention should be defined based on not just a name of the term but a meaning of the term and contents throughout the present invention.

Further, throughout the specification, unless explicitly described to the contrary, when any part “comprises” any component, it will be understood to further comprise another component without excluding any other elements.

An embodiment of the present invention will be described more fully hereinafter with reference to the accompanying drawings so as to be easily implemented by those skilled in the art. However, the present invention may be embodied in many different forms and are limited to embodiments described herein.

Specific matters including problems to be solved for the present invention, solutions of the problems, and the effects of the invention for the present invention are included in embodiments and drawings to be described below. Advantages and features of the present invention, and methods for accomplishing the same will be more clearly understood from embodiments described in detail below with reference to the accompanying drawings.

A pulling compensation apparatus for a vehicle of the present invention is applied to all vehicle which need to compensate a height on a slope with a car, an electric cart, a scooter, a wheelchair, etc., and to prevent pulling and rollover accidents caused by motion inertia, shocks from the road surface, etc. In addition, all phenomena such as movement of the center of gravity caused by inclination on a slope and pulling or overturning due to inertial force generated by stopping or curved motion of the vehicle are indicated as pulling for convenience. In addition, shocks to be applied by the unevenness or slope of the road surface or a load change caused by an obstacle, etc. are indicated as shocks for convenience.

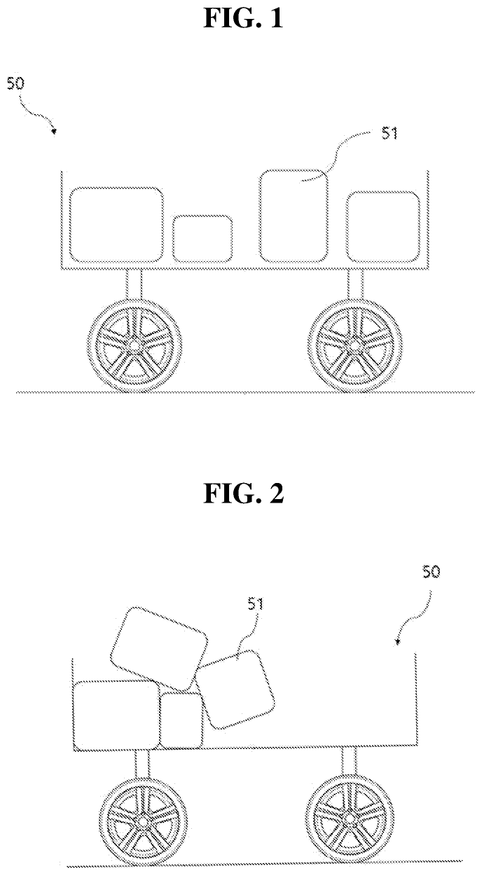

As illustrated in FIG. 1, when a vehicle 50 carrying goods 51 suddenly stops, as illustrated in FIG. 2, the load of the vehicle 50 itself including the goods 51 is pulled to one side, and there is a risk of overturning in severe cases. Here, the goods 51 refer to objects to be carried by the vehicle 50, and include, for example, a passenger, luggage, etc.

More specifically, when the vehicle 50 stops suddenly or turns on an abrupt curve, as illustrated in FIG. 2, while the vehicle 50 and the goods 51 are pulled by motion inertia, the entire load of the vehicle 50 including the goods 51 50 is pulled in one direction. In addition, even when the vehicle 50 is running on an inclined road, it is natural that the vehicle 50 and the goods 51 are pulled in a direction in which the road is inclined.

A situation in which a running road surface of the vehicle 50 is inclined in one direction includes not only an uphill, a downhill, but also running road surfaces inclined to both left and right sides based on the moving direction of the vehicle 50. That is, when the vehicle 50 runs on a road surface inclined to the left or right, as described above, as the vehicle 50 is inclined toward a lower side of both directions, the overall load may be pulled to the lower side.

In addition, this phenomenon may occur in the same manner as the inertial force acts to the left or right based on the moving direction of the vehicle 50 when entering a curved road even if the vehicle 50 is running on a flat road that is not inclined. That is, when the vehicle 50 runs on a left-turn curve, the inertial force acts to the right, so that the entire load of the vehicle 50 including the goods 51 is pulled to the right. On the contrary, when the vehicle 50 runs on a right-turn curve, the inertial force acts to the left, so that the entire load of the vehicle 50 including the goods 51 is pulled to the left. Accordingly, there is a problem in a faster and more comfortable running because a ride comfort of a passenger may be deteriorated or a risk of overturning the vehicle may occur.

Hereinafter, the pulling compensation apparatus for the vehicle of the present invention will be described in detail with reference to the accompanying drawings.

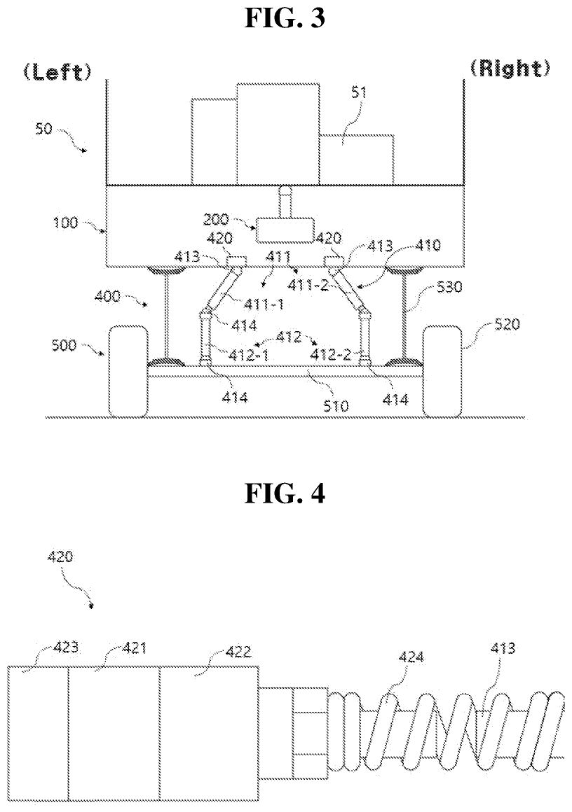

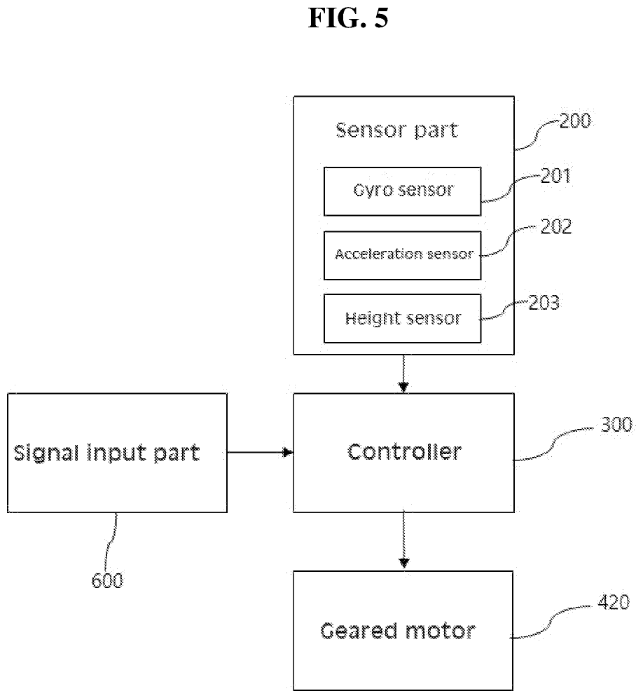

Referring to FIGS. 3 to 8, a pulling compensation apparatus for a vehicle according to a preferred embodiment of the present invention includes a main body part 100 capable of loading a power engine of the vehicle 50 and goods 51 or carrying people, a transfer part 500 transferring the main body part 100, a sensor part 200 sensing a slope of the main body part 100 and pulling and a height due to motion inertia to transmit a signal, a controller 300 embedded with a computer receiving the signal of the sensor part 200, and a pulling reduction part 400 controlled by the controller 300 to reduce the pulling and shocks of the main body part 100. In addition, when the pulling of the main body part 100 and an obstacle are sensed by the sensor part 200, the pulling reduction part 400 may vary the height to reduce the pulling and shocks of the main body part 100.

More specifically, the main body part 100 means a receiving space of the vehicle 50, and forms a space in which the passengers including a driver and the goods 51 are loaded. In addition, the power engine of the vehicle 50, the sensor part 200, and the controller 300 are provided inside the main body part 100. In addition, the transfer part 500 is provided to support the main body part 100 and be in contact with the ground so that the main body part 100 may be transferred.

The transfer part 500 includes wheels 520, a shaft 510 connecting the wheels 520, and a buffer spring part 530 provided between the transfer part 500 and the main body part 100 to buffer shocks to be applied to the main body part 100. The buffer spring part 530 may be provided in various forms such as a leaf spring, a coil spring, a fluid spring, and the like.

Next, the sensor part 200 is provided inside and outside the main body part 100 and serves to sense pulling, a slope, and a height due to motion inertia of the main body part 100 to transmit a signal.

More specifically, the sensor part 200 includes a gyro sensor 211 that senses the inclination of the main body part 100, an acceleration sensor 212 that senses pulling due to motion inertia of the main body part 100, and a height sensor 213 that senses the height of the main body part 100.

First, the gyro sensor 211 is fixed to the inside of the main body part 100. In addition, the gyro sensor 211 may sense the pulling of the main body part 100 generated by the pulling due to motion inertia of the main body part 100 and the goods 51 when the vehicle 50 suddenly stops or runs on a sharp curve.

In addition, when the vehicle 50 is placed on a slope and the main body part 100 is inclined, the gyro sensor 211 may sense the inclination of the main body part 100. Next, the acceleration sensor 212 is provided with the gyro sensor 211 inside the main body part 100. In addition, the acceleration sensor 212 measures the acceleration due to the movement of the main body part 100 so that the pulling of the main body part 100 may be sensed.

In addition, a plurality of height sensors 213 is provided in the pulling reduction part 400 to measure the height of the main body part 100.

Next, the controller 300 is provided on one side of the main body part 100 and receives a signal transmitted from the sensor part 200 to control the pulling reduction part 400 so as to reduce the pulling and the inclination of the main body part 100.

More specifically, when the main body part 100 is pulled by motion inertia, the controller 300 controls the pulling reduction part 400 to lift one side of the main body part 100 and lower the other side of the main body part 100, thereby reducing the pulling and the inclination of the main body part 100.

In addition, the controller 300 receives a signal from the height sensor 213 and controls the pulling reduction part 400 to lift or lower the main body part 100, so that the height of the main body part 100 may be maintained at an appropriate height.

In addition, when it is difficult to adjust the height of the main body part 100 through the pulling reduction part 400 due to a steep slope, the controller 300 senses the height above an appropriate range through the height sensor 213 and stops the operation of the pulling reduction part 400 in order to maintain the leveling of the main body part 100. Accordingly, it is possible to prevent an excessive load from being applied to the pulling reduction part 400.

In addition, when the vehicle 50 is placed on a steep slope, if the goods are loaded in the main body part 100, the controller 300 lowers the height of the main body part 100 to prevent the main body part 100 from overturning due to a steep slope, so that the center of gravity of the vehicle 50 may be lowered.

In addition, when the weight of the main body part 100 is lowered due to a small number of goods 51 and passengers loaded in the vehicle 50, the height of the pulling reduction part 400 is increased to increase air resistance during running, thereby reducing the ride comfort. In addition, when the weight of the main body part 100 is increased due to a large number of goods 51 and passengers loaded in the vehicle 50, the height of the pulling reduction part 400 is lowered, thereby reducing the ride comfort. At this time, the controller 300 receives the height signals of the main body part 100 and the pulling reduction part 400 through the height sensor 213, and controls the pulling reduction part 400 according to the height signals, so that the heights of the main body part 100 and the pulling reduction part 400 are maintained at appropriate heights.

Next, the pulling reduction part 400 includes a plurality of geared motors 420 provided on one side of the main body part 100 and a plurality of connection arms 410 connected to the main body part 100 and provided to be rotated by the geared motors 420.

First, the connection arm 410 supports the main body part 100 and is rotated by the geared motor 420 so that the height of the main body part 100 may be varied. More specifically, the connection arm 410 includes a main connection arm 411 connected to the lower side of the main body part, and an auxiliary connection arm 412 connected to an end of the main connection arm 411 and connected to the transfer part 500.

In addition, the main connection arm 411 is connected to a partial rotation shaft 413 provided on the bottom of the main body part 100. The partial rotation shaft 413 allows the main connection arm 411 to be rotated upward or downward from the bottom of the main body part 100. In addition, the partial rotation shaft 413 serves to limit a rotation angle of the main connection arm 411 so that the rotation angle of the main connection arm 411 does not exceed a predetermined range. In addition, the partial rotation shaft 413 is connected to the geared motor 420 to receive power. Accordingly, the main connection arm 411 may be rotated by the geared motor 420.

In addition, the main connection arm 411 includes a first main connection arm 411-1 provided on the left side of the main body part 100 and a second main connection arm 411-2 provided on the right side of the main body part 100.

Next, the auxiliary connection arm 412 is connected to the end of the main connection arm 411 and the transfer part 500, so that the height of the main body part 100 may be naturally varied when the main connection arm 411 is rotated. In addition, a connection arm joint 414 is provided at each end of the auxiliary connection arm 412 and the main connection arm 411. Accordingly, when the main connection arm 411 is rotated upward, a connection angle between the auxiliary connection arm 412 and the main connection arm 411 may be decreased, and the height of the main body part 100 may be decreased. On the contrary, when the main connection arm 411 is rotated downward, the connection angle between the auxiliary connection arm 412 and the main connection arm 411 may be increased, and the height of the main body part 100 may be increased. Accordingly, the auxiliary connection arm 412 allows the height of the main body part 100 to be more easily varied than when the main connection arm 411 is directly connected to the transfer part 500.

In addition, the auxiliary connection arm 412 consists of a first auxiliary connection arm 412-1 connected to the first main connection arm 411-1, and a second auxiliary connection arm 412-2 connected to the second main connection arm 411-2.

Next, the geared motor 420 is connected to the partial rotation shaft 413 and serves to rotate the main connection arm 411. More specifically, the geared motor 420 includes a DC motor 421 provided to perform forward and reverse rotation, a decelerator 422 provided inside the geared motor 420 and connected to the DC motor 421, a twist spring 424 provided on one side of the geared motor 420, a partial rotation shaft 413 connecting the twist spring 424 and the main connection arm 411, and an electronic brake 423 provided at the rear end of the DC motor 421.

First, the DC motor 421 is controlled to perform forward or reverse rotation by the controller 300, and transmits power to the decelerator 422.

Next, the decelerator 422 allows the number of rotations of the DC motor 421 to be changed. That is, the decelerator 422 enables the power transmitted from the DC motor 421 to generate a greater force. In addition, the decelerator 422 is connected to the partial rotation shaft 413 by the twist spring 424 so that power may be transmitted to the main connection arm 411.

Next, the electronic brake 423 is provided at the rear end of the DC motor 421 and is controlled by the controller 300 to prevent a shaft (not illustrated) of the DC motor 421 from rotating. That is, the electronic brake 423 fixes the twist spring 424 and the partial rotation shaft 413 to support the main body part 100 so that the main connection arm 411 is not rotated in an unintended direction by a sudden load applied to the main body part 100. At this time, if the DC motor 421 is operated by the controller 300, the braking of the electronic brake 423 is released and the DC motor 421 may easily transmit power.

Next, the twist spring 424 is provided in the form of a coil connecting the decelerator 422 and the partial rotation shaft 413. For this reason, when a sudden load is applied to the partial rotation shaft 413, the twist spring 424 becomes more twisted and absorbs shocks, so that the load applied to the geared motor 420 may be reduced. That is, the power generated from the decelerator 422 may be transmitted to the partial rotation shaft 413 through the twist spring 424. In addition, when the electronic brake 423 is provided between the DC motor 421 and the decelerator 422, the power may be transmitted to the partial rotation shaft 413 through the decelerator 422 and the twist spring 424.

Next, a signal input part 600 transmits a signal to the controller 300 by a user's operation to selectively control the pulling reduction part 400. In more detail, when the vehicle 50 passes through a difficulty, the user may transmit a signal to the controller 300 through the signal input part 600. In addition, the controller 300 receiving the signal controls a pair of main connection arms 411 to rotate downward or upward, thereby lowering or lifting the main body part 100 so as to pass through the difficulty.

Hereinafter, a state in which the pulling of the main body part 100 is reduced by using the pulling reduction part 400 will be described in more detail.

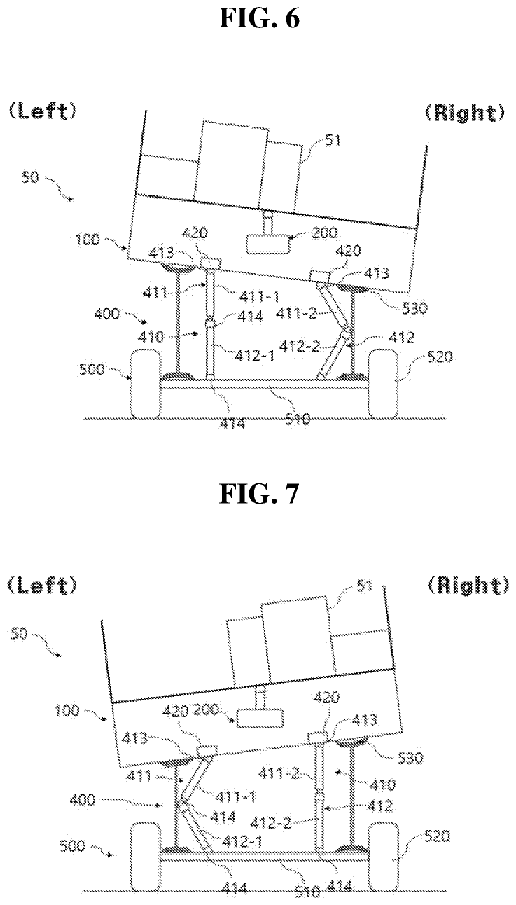

Referring to FIG. 6, when the main body part 100 and the goods 51 are pulled to the left as the vehicle 50 runs on a right sharp curve, the sensor part 200 senses the left pulling of the main body part 100 caused by motion inertia to transmit a signal. In addition, the controller 300 receives a signal from the sensor part 200 and controls the geared motor 420 to rotate the first main connection arm 411-1 downward and rotate the second main connecting arm 411-2 upward. That is, when the first main connection arm 411-1 is rotated downward, the connection angle between the first main connection arm 411-1 and the first auxiliary connection arm 412-1 increases, and the left side of the main body part 100 is lifted. In addition, when the second main connection arm 411-2 is rotated upward, the connection angle between the second main connection arm 411-2 and the second auxiliary connection arm 412-2 decreases, and the right side of the main body part 100 is lowered. Through this, when the main body part 100 is pulled to the left, the pulling reduction part 400 lifts the left side of the main body part 100 and lowers the right side so that the pulling may be reduced.

Further, referring to FIG. 7, when the main body part 100 and the goods 51 are pulled to the right as the vehicle 50 runs on a left sharp curve, the sensor part 200 senses the right pulling of the main body part 100 caused by motion inertia to transmit a signal. In addition, the controller 300 receives a signal from the sensor part 200 and controls the geared motor 420 to rotate the first main connection arm 411-1 upward and rotate the second main connecting arm 411-2 downward. That is, when the first main connection arm 411-1 is rotated upward, the connection angle between the first main connection arm 411-1 and the first auxiliary connection arm 412-1 decreases, and the left side of the main body part 100 is lowered. In addition, when the second main connection arm 411-2 is rotated downward, the connection angle between the second main connection arm 411-2 and the second auxiliary connection arm 412-2 increases, and the right side of the main body part 100 is lifted. Through this, when the main body part 100 is pulled to the right, the pulling reduction part 400 lifts the right side of the main body part 100 and lowers the left side so that the pulling may be efficiently reduced. That is, the pulling reduction part 400 lifts the right side of the main body 100 and lowers the left side thereof until the pulling due to motion inertia of the main body part 100 stops. At this time, the sensor part 200 is fixed to the inside of the main body part 100, so that the gyro sensor 211 and the acceleration sensor 212 may perform a function inside the main body part 100.

In addition, even when the vehicle 50 runs on an inclined road surface, the pulling reduction part 400 varies the height of the main body part 100 so that the inclined direction of the main body part 100 is higher, so that pulling of the main body part 100 may be reduced. In addition, even when the vehicle 50 is pulled forward or backward, the height of the main body part 100 may be varied so that the pulling may be reduced.

Hereinafter, a second embodiment of the pulling compensation apparatus for the vehicle of the present invention will be described. In the embodiment, compared to the first embodiment, the configurations of the main body part, the sensor part, the controller, the pulling reduction part, etc. are duplicated, but there some differences in that the wheels of the transfer part are not connected to each other by a shaft, but separated from each other, and the separated one side of the shaft is connected to the partial rotation shaft and serves as the main connection arm and the auxiliary connection arm. Accordingly, in the embodiment, the configurations duplicated with the first embodiment cite the description of the first embodiment.

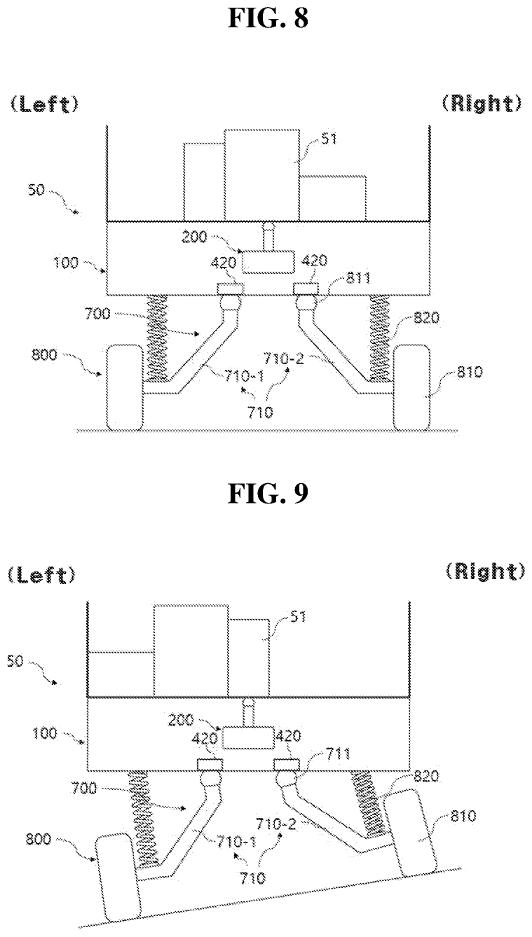

Referring to FIGS. 8 to 10, a plurality of wheels 810 provided in the transfer part 800 are provided to be individually moved to the left and right of the main body part 100. In addition, the plurality of connection arms 710 are connected to the wheels 810 to support the main body part 100. That is, the pulling reduction part 700 may be provided between the transfer part 800 and the main body part 100 to support the main body part 100. In addition, since the connection arm 710 is connected to the wheel 810, there is no member interfering with the rotation of the connection arm 710 like the shaft 510 of the first embodiment, so that the connection arm 710 may be easily rotated even if the auxiliary connection arm 412 is not provided. Therefore, as illustrated in FIG. 9, when the main body part 100 is pulled to the left or the main body part 100 is inclined to the left, the first connection arm 710-1 provided on the left side of the main body part 100 is rotated downward by the geared motor 420 to lift the left side of the main body part 100, and the second connection arm 710-2 provided on the right side of the main body part 100 is rotated upward to lower the right side of the main body part 100. As a result, the left pulling of the main body part 100 may be effectively reduced.

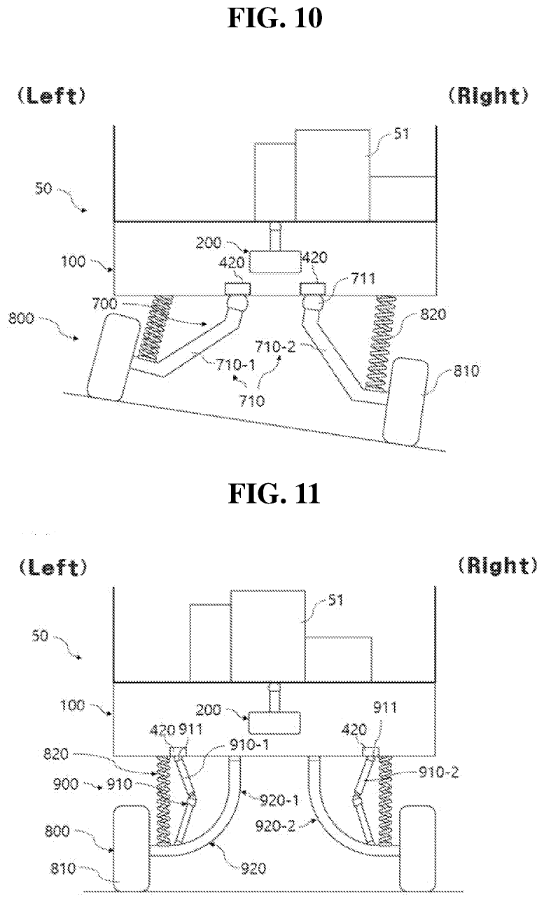

Further, as illustrated in FIG. 10, when the main body part 100 is pulled to the right or the main body part 100 is inclined to the right, the first connection arm 710-1 provided on the left side of the main body part 100 is rotated upward by the geared motor 420 to lower the left side of the main body part 100, and the second connection arm 710-2 provided on the right side of the main body part 100 is rotated downward to lift the right side of the main body part 100. As a result, the right pulling of the main body part 100 may be effectively reduced.

At this time, as the wheels 810 are provided to be individually moved, the buffer spring parts 820 are installed on the wheels 810, respectively, and may be provided in various forms such as a coil spring, a leaf spring, and a fluid spring. In addition, the partial rotation shaft 711 is provided in a front-rear direction of the main body part 100 so that the connection arm 710 is rotated in a left-right direction of the main body part 100. As a result, the distortion of the main body part 100 may be prevented, but the wheels of the transfer part 800 may not stably contact the ground.

Hereinafter, a third embodiment of the pulling compensation apparatus for the vehicle of the present invention will be described. In the embodiment, as compared with the first embodiment, the configurations of the main body part, the sensor part, the controller, etc. are duplicated, but there are some differences in that as compared with the pulling reduction part the second embodiment, a gap between the wheels of the transfer part and the geared motor rotating the partial rotation shaft may be reduced, so that the geared motor may lift or lower the main body part with a smaller force. Accordingly, in the embodiment, the configurations duplicated with the first embodiment cite the description of the first embodiment.

Referring to FIGS. 11 to 13, the pulling reduction part 900 includes a guide arm 920 connected to the wheel 810 of the transfer part 800 and the lower side of the main body part 100, a connection arm 910 connected to one side of the guide arm, and the buffer spring part 820.

More specifically, the guide arm 920 includes a first guide arm 920-1 provided on the left side of the main body part 100 and a second guide arm 920-2 provided on the right side of the main body part 100. In addition, the guide arm 920 is connected to the lower side of the main body part 100 by a hinge or the partial rotation shaft 711 so that the main body part 100 may be rotated in the front-rear direction.

In addition, the buffer spring part 820 is connected to the lower end of the guide arm 920 and the lower side of the main body part 100 to support the transfer part 800 and the main body part 100 and buffer the shocks.

Next, the connection arm 910 consists of a first connection arm 910-1 connected to the first guide arm 920-1, and a second connection arm 910-2 connected to the second guide arm 920-2. In addition, the connection arm 910 is provided at the lower end of the guide arm 920 and the lower portion of the main body part 100, and disposed adjacent to the buffer spring part 820. In addition, since the guide arm 920 rotates to the left and right to buffer the vehicle 50, if the length of the guide arm 920 is formed to be short, a rotation radius is small, and thus, a buffering effect decreases and the stable grounding of the wheel 810 may become difficult. Accordingly, in order for the connection arm 910 to lift or lower the main body part 100 more easily, the connection arm 910 is disposed between the transfer part 800 and the lower end of the guide arm 920. In addition, the connection arm 910 is connected to a partial rotation shaft 911 connected to the geared motor 420 provided in the main body part 100 so as to be easily rotated upward or downward. At this time, the connection arm 910 is rotated so that the height of the main body 100 may be varied.

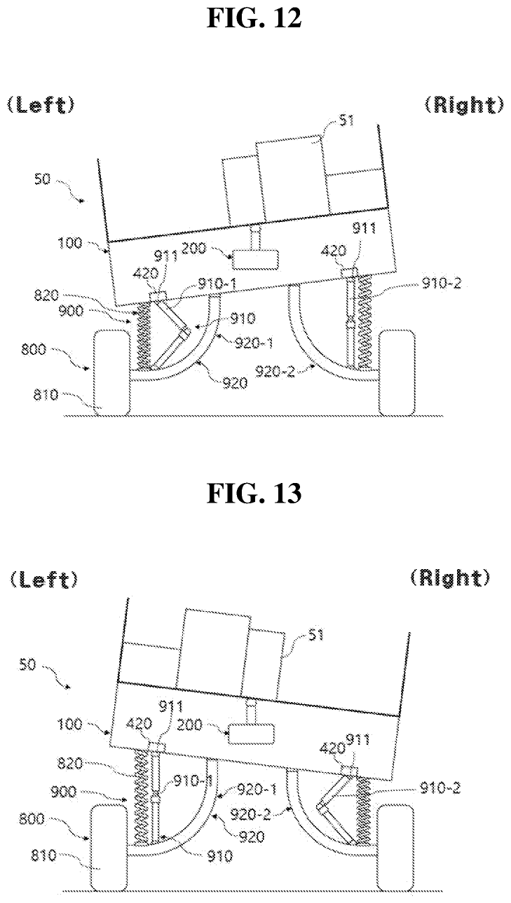

Therefore, when the main body part 100 is pulled to the right or left by the running of the vehicle 50, as illustrated in FIGS. 12 and 13, a direction in which the main body part 100 is pulled is lifted and an opposite side thereto is lowered, thereby reducing the pulling of the main body part 100.

Hereinafter, a fourth embodiment of the pulling compensation apparatus for the vehicle of the present invention will be described. In the embodiment, as compared with the first embodiment, the configurations of the main body part, the sensor part, the controller, etc. are duplicated, but like the second embodiment, there are some differences in that there is no joint in the connecting arm, a partial rotation shaft through which the connection arm directly connected to the wheel may move up and down is provided in a left-right direction of the main body part so that the connection arm is rotated in a front-rear direction, and a spring buffering the shocks applied to the main body part is provided so that the shocks may be absorbed through twisting. Accordingly, in the embodiment, the configurations duplicated with the first embodiment cite the description of the first embodiment.

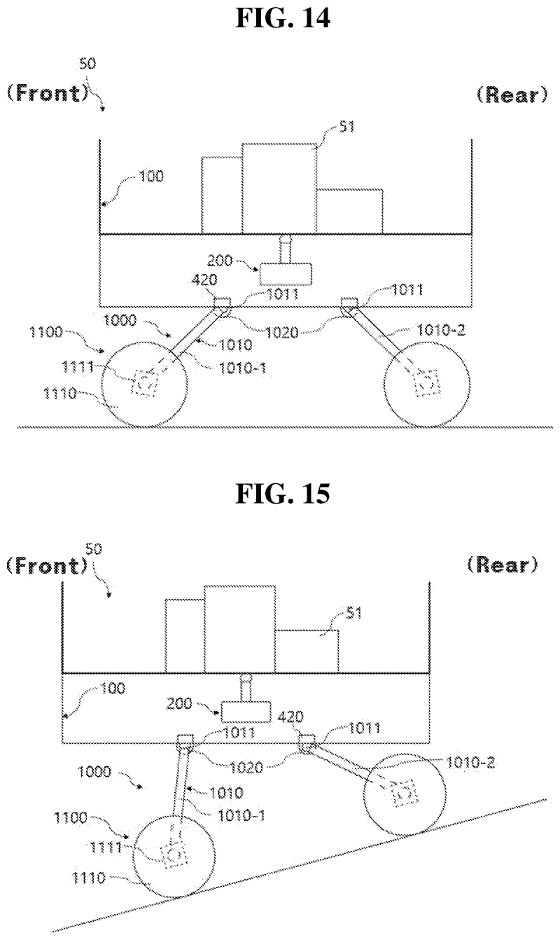

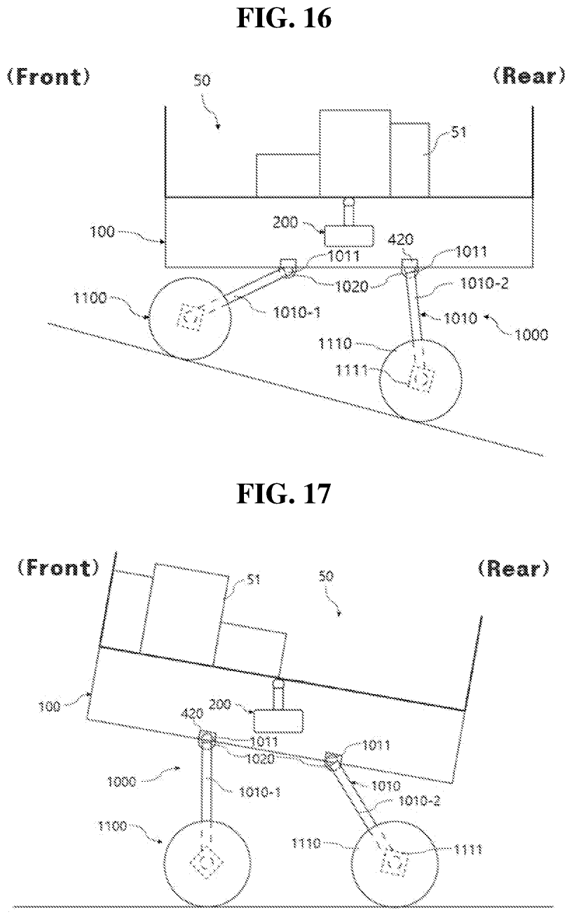

Referring to FIGS. 14 to 16, a pulling reduction part 1000 includes a connection arm 1010 connected to a wheel 1110, and a twist buffer spring 1020 provided at an upper end of the connection arm 1010. In addition, the twist buffer spring 1020 is provided at a portion corresponding to an opposite side to a portion connected to the geared motor 420 of both ends of the partial rotation shaft 1011 to support the load of the main body part 100. In addition, the twist buffer spring 1020 supports and twists the main body part 100 like the twist spring 424 connected to the geared motor 420 of the first embodiment, so that the shocks applied to the main body part 100 may be absorbed.

More specifically, the connection arm 1010 includes a first connection arm 1010-1 provided on the front of the main body part 100 and a second connection arm 1010-2 provided on the rear of the main body part 100. In addition, the connection arm 1010 is connected to the partial rotation shaft 1011 provided at the lower side of the main body part 100 so as to be rotated upward or downward by the geared motor 420. That is, when the first connection arm 1010-1 is rotated downward and the second connection arm 1010-2 is rotated upward, the front of the main body part 100 may be lifted and the rear of the main body part 100 may be lowered. On the contrary, when the first connection arm 1010-1 is rotated upward and the second connection arm 1010-2 is rotated downward, the front of the main body part 100 may be lowered and the rear of the main body part 100 may be lifted. At this time, the front or the rear of the main body part 100 is lifted or lowered by the twist buffer spring 1020 and the twist spring 424 supporting the main body part 100 and the transfer part 1100, and the connection arm 1010.

In addition, the twist spring 424 is provided between the partial rotation shaft 1011 provided at the upper end of the connection arm 1010 and the geared motor 420, and the twist buffer spring 1020 is provided at the end of the partial rotation shaft 1011 corresponding to an opposite side at which the partial rotation shaft 1011 and the twist spring 424 are connected to each other. In addition, when a load is generated on the connection arm 1010, the twist spring 424 and the twist buffer spring 1020 are twisted to buffer the shocks applied to the connection arm 1010, so that the load applied to the geared motor 420 may be reduced.

In addition, a wheel driving motor 1111 may be connected to the wheel 1110 of the transfer part 1100 and the inside of the connection arm 1010 to be supported, respectively. In addition, it is natural that the wheel driving motor 1111 includes a battery and an electric wire provided to supply power to the wheel driving motor 1111, and transmits power to the wheel 1110 so that the wheel 1110 may be individually driven.

In addition, when the vehicle 50 is suddenly braked while a large vehicle such as a dump truck suddenly stops in front of the vehicle 50, as illustrated in FIG. 17, the first connection arm 1010-1 is rotated downward and the second connection arm 1010-2 is rotated upward, so that the front of the main body part 100 is lifted and the rear of the main body part 100 is lowered. For this reason, when the vehicle 50 collides with the large vehicle, the main body part 100 is prevented from being brought into the lower side of the large vehicle, so that a bumper means which may be provided in front of the main body part 100 may be working, thereby allowing a driver of the vehicle 50 to be safer.

Hereinafter, a fifth embodiment of the pulling compensation apparatus for the vehicle of the present invention will be described. In the embodiment, as compared with the first embodiment, the configurations of the main body part, the sensor part, the controller, etc. are duplicated, and in the configuration of the fourth embodiment, there are some differences in that the twist spring, which has served as a buffer between the partial rotation shaft and the main body part, is changed to a coil spring or a fluid spring, and a position where the buffer spring is coupled is changed. Accordingly, in the embodiment, the configurations duplicated with the first embodiment cite the description of the first embodiment.

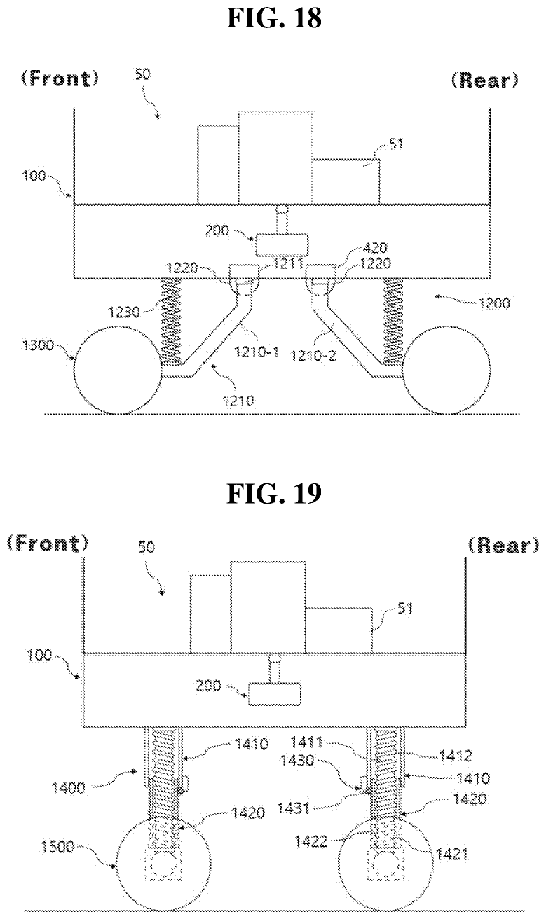

Referring to FIG. 18, a pulling reduction part 1200 includes a connection arm 1210 connected to a lower side of the main body part 100 through the partial rotation shaft 1211, a twist spring 1220 provided to rotate the connection arm 1210 and a partial rotation shaft 1211, and a buffer spring 1230 provided between the lower end of the connection arm 1210 and the main body part 100 to support and buffer the main body part 100.

More specifically, the connection arm 1210 is connected to the geared motor 420 through the partial rotation shaft 1211 and the twist spring 1220 to be rotated upward or downward, so that the height of the main body part 100 may be varied. At this time, the connection arm 1210 includes a first connection arm 1210-1 provided on the front of the main body part 100 and a second connection arm 1210-2 provided on the rear of the main body part 100.

In addition, the twist spring 1220 is twisted so that the shocks applied to the geared motor 420 that rotates the connection arm 1210 may be reduced, so as to buffer the shocks.

In addition, the buffer spring 1230 is disposed perpendicular to the ground between the lower end of the connection arm 1210 and the main body part 100 so that the shocks applied to the main body part 100 is reduced. In addition, when the connection arm 1210 moves up and down toward the front or rear, the buffer spring 1230 may reduce the stress applied to both sides of the partial rotation shaft 1211 provided at the left and right below the main body part 100, thereby preventing the lower distortion of the vehicle 50. Therefore, the buffer spring 1230 is disposed at a portion of the lower end of the connection arm 1210 adjacent to the transfer part 1300, so that the distortion applied to the lower portion of the main body 100 may be more easily prevented.

Hereinafter, a sixth embodiment of the pulling compensation apparatus for the vehicle of the present invention will be described. In the embodiment, as compared with the first embodiment, the configurations of the main body part, the sensor part, the controller, etc. are duplicated, but there are some differences in that a rack and a pinion gear are provided in the pulling reduction part, so that the height of the main body part may be changed with less power of the geared motor. Accordingly, in the embodiment, the configurations duplicated with the first embodiment cite the description of the first embodiment.

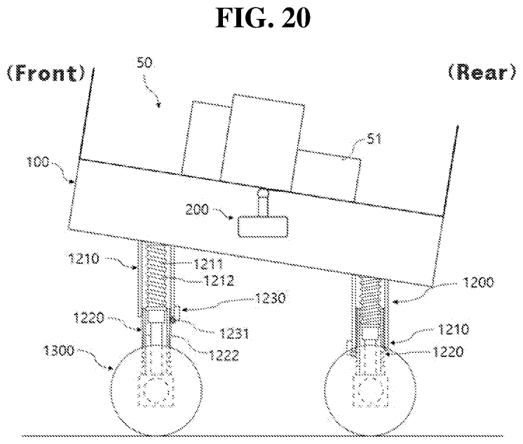

Referring to FIGS. 19 and 20, a pulling reduction part 1400 includes an outer pillar 1410 provided at the lower side of the main body part 100 and having a receiving space therein, an inner pillar 1420 provided to be moved inside the outer pillar 1410 and having a rack 1422, a coil-type or fluid-type buffer spring 1412 provided inside the outer pillar 1410 and the inner pillar 1420, shock absorbers 1411 and 1421 that support the main body part 100 together with the buffer spring 1412 and are provided for a buffering action, and a geared motor 1430 provided on one side of the outer pillar 1410 and having a pinion gear 1431 provided to engage with the rack 1422 to lift the inner pillar 1420. In addition, when the pulling of the main body part 100 is sensed by the sensor part 200, the pulling reduction part 1400 may reduce the pulling of the main body part 100 so that the height of the main body part 100 is varied. In addition, the shock absorbers 1411 and 1421 and the buffer spring 1412 allow the shocks applied to the main body part 100 to be buffered between the main body part 100 and the transfer part 1300.

More specifically, in the outer pillar 1410 and the inner pillar 1420, the outer shock absorber 1411 and the inner shock absorber 1421 provided at the insides of the outer pillar 1410 and the inner pillar 1420 are provided inside the buffer spring 1412 when the buffer spring 1412 is a coil type, and provided outside the buffer spring 1412 when the buffer spring 1412 is a fluid type. At this time, the inner side of the inner pillar 1420 may be provided in the same shape as the outer shock absorber 1411 or may perform the same function, and the upper portion of the buffer spring 1412 may be provided in the same shape as the inner shock absorber 1421. The pulling reduction part 1400 includes a buffer spring 1412 provided in a form surrounding the outer circumferential surfaces of the outer shock absorber 1411 and the inner shock absorber 1421.

In addition, the inner pillar 1420 includes an inner shock absorber 1421 provided on the inner side of the inner pillar 1420 and a rack 1422 provided on one side of the outer circumferential surface of the inner pillar 1420. In addition, the inner pillar 1420 is connected to the transfer part 1500.

Further, the geared motor 1430 includes the twist spring 424 and the pinion gear 1431 driven by the geared motor 1430. In addition, the pinion gear 1431 is disposed so as to engage with the rack 1422 so that the rack 1422 may be transferred upward or downward by the geared motor 1430. That is, the geared motor 1430 allows the inner pillar 1420 to be drawn into the outer pillar 1410 or be drawn out from the outer pillar 1410. For example, when the vehicle 50 is suddenly stopped or inclined forward, the inner pillar 1420 provided in front of the main body part 100 is drawn out downward by the geared motor 1430, and the inner pillar 1420 provided at the rear of the main body part 100 is drawn in upward, so that the front pulling of the main body part 100 may be reduced. On the contrary, when the vehicle 50 is suddenly accelerated or inclined backward, the inner pillar 1420 provided in front of the main body part 100 is drawn in upward by the geared motor 1430, and the inner pillar 1420 provided at the rear of the main body part 100 is drawn out downward, so that the rear pulling of the main body part 100 may be reduced. In this case, the geared motor 1430 may be provided on both sides of the outer pillar 1410. In addition, the pinion gear 1431 is connected to the twist spring 424 and the partial rotation shaft 413 to reduce the shocks transmitted from the vehicle 50 and to support the main body part 100 at the same time.

In addition, the outer shock absorber 1411 and the inner shock absorber 1421 provided inside the outer pillar 1410 and the inner pillar 1420 are connected to each other, so that the shocks applied to the main body part 100 may be buffered between the main body part 100 and the transfer part 1500.

In addition, the buffer spring 1412 is also provided between the lower end of the inner pillar 1420 and the main body part 100 so that the shocks applied to the main body part 100 may be buffered.

Accordingly, the height of the main body part 100 may be varied with less power of the geared motor 1430, and the pulling reduction part 1400 is formed integrally to be more easily provided.

As described above, the present invention has been described with the six embodiments, but since the example of a structure that is newly changed from the existing vehicle is given, conventional devices such as a steering device, a shock absorber, and a knuckle joint that are naturally provided.

As such, according to the present invention, there is an effect of preventing rollover accidents by reducing the puling due to motion inertia when the vehicle stops or suddenly rotates.

In addition, the present invention has an effect of easily passing through difficulties, such as an inclined road surface, a curved road, and a road submerged in water.

1. A pulling compensation apparatus for a vehicle comprising:
a main body part capable of loading a power engine of the vehicle and goods or carrying people;
a transfer part transferring the main body part;
a sensor part sensing a height and a slope of the main body part, pulling due to motion inertia and an obstacle to transmit a signal;
a controller embedded with a computer receiving the signal of the sensor part; and
a pulling reduction part controlled by the controller to reduce the pulling and shocks of the main body part,
wherein when the pulling of the main body part and the obstacle are sensed by the sensor part, the pulling reduction part varies the height to reduce the pulling and shocks of the main body part.

2. The pulling compensation apparatus for the vehicle of claim 1, wherein the pulling reduction part comprises
a plurality of geared motors provided on one side of the main body part;
a plurality of connection arms connected to the other side of the main body part and provided to be rotated by the geared motors; and
a buffer spring part provided between the main body part and the transfer part,
wherein the buffer spring part supports the main body part and buffers the shocks applied to the main body part, and
the connection arm is rotated by the geared motor while supporting the main body part, so that the height of the pulling reduction part may be varied.

3. The pulling compensation apparatus for the vehicle of claim 1, further comprising:
a signal input part provided at one side of the main body part,
wherein the signal input part transmits a signal to the controller by a user's operation to selectively control the pulling reduction part.

4. The pulling compensation apparatus for the vehicle of claim 1, wherein the sensor part comprises
a plurality of height sensors that senses the height of the main body part;
a gyro sensor that senses the inclination of the main body part; and
an acceleration sensor that senses pulling due to motion inertia of the main body part.

5. The pulling compensation apparatus for the vehicle of claim 1, wherein the geared motor further comprises
an electronic brake provided at a rear end of the geared motor,
wherein the electronic brake prevents the geared motor from being rotated by a load applied to the main body part and the transfer part.

6. A pulling compensation apparatus for a vehicle comprising:
a main body part capable of loading a power engine of the vehicle and goods or carrying people;
a transfer part transferring the main body part;
a sensor part sensing a height and a slope of the main body part, pulling due to motion inertia and an obstacle to transmit a signal;
a controller embedded with a computer receiving the signal of the sensor part; and
a pulling reduction part controlled by the controller to reduce the pulling and shocks of the main body part,
wherein the pulling reduction part comprises
a plurality of geared motors provided at a lower portion of the main body part;
a buffer spring supporting and buffering the main body part;
a partial rotation shaft that is connected to the geared motor and provided in a left-right direction of the main body part to be rotated in a front-rear direction of the main body part;
a connection arm connected to the partial rotation shaft; and
a twist spring provided between the geared motor and the partial rotation shaft,
wherein when the pulling and the shocks of the main body part are sensed by the sensor part, the pulling reduction part varies the height to reduces the pulling of the main body part, and
the twist spring transmits the power by the geared motor to the partial rotation shaft, and reduces a sudden load applied to the geared motor.

7. The pulling compensation apparatus for the vehicle of claim 6, wherein the pulling reduction part comprises
a plurality of geared motors provided on one side of the main body part;
a plurality of connection arms connected to the other side of the main body part and provided to be rotated by the geared motors; and
a buffer spring part provided between the main body part and the transfer part,
wherein the buffer spring part supports the main body part and buffers the shocks applied to the main body part, and
the connection arm is rotated by the geared motor while supporting the main body part, so that the height of the pulling reduction part may be varied.

8. The pulling compensation apparatus for the vehicle of claim 7, wherein the geared motor comprises
a twist spring provided on one side of the geared motor; and
a partial rotation shaft connecting the twist spring and a connection arm,
wherein the twist spring transmits the power to the partial rotation shaft, and supports the main body part while reducing the shocks transmitted from the partial rotation shaft.

9. The pulling compensation apparatus for the vehicle of claim 6, further comprising:
a signal input part provided at one side of the main body part,
wherein the signal input part transmits a signal to the controller by a user's operation to selectively control the pulling reduction part.

10. The pulling compensation apparatus for the vehicle of claim 6, wherein the sensor part comprises
a plurality of height sensors that senses the height of the main body part;
a gyro sensor that senses the inclination of the main body part; and
an acceleration sensor that senses pulling due to motion inertia of the main body part.

11. The pulling compensation apparatus for the vehicle of claim 6, wherein the geared motor further comprises
an electronic brake provided at a rear end of the geared motor,
wherein the electronic brake prevents the geared motor from being rotated by a load applied to the main body part and the transfer part.

12. A pulling compensation apparatus for a vehicle comprising:
a main body part capable of loading a power engine of the vehicle and goods or carrying people;
a transfer part transferring the main body part;
a sensor part sensing a height and a slope of the main body part, pulling due to motion inertia and an obstacle to transmit a signal;
a controller embedded with a computer receiving the signal of the sensor part; and
a pulling reduction part controlled by the controller to reduce the pulling and shocks of the main body part,
wherein the pulling reduction part comprises
an outer pillar provided at the lower side of the main body part and having a receiving space therein;
an inner pillar provided to be moved inside the outer pillar and having a rack;
a buffer spring provided inside the outer pillar and the inner pillar;
shock absorbers that support the main body part together with the buffer spring and are provided for a buffering action; and
a geared motor provided on one side of the outer pillar and having a pinion gear provided to engage with the rack to lift the inner pillar,
wherein when the pulling of the main body part and the obstacle are sensed by the sensor part, the pulling reduction part varies the height to reduce the pulling and shocks of the main body part.

13. The pulling compensation apparatus for the vehicle of claim 12, further comprising:
a signal input part provided at one side of the main body part,
wherein the signal input part transmits a signal to the controller by a user's operation to selectively control the pulling reduction part.

14. The pulling compensation apparatus for the vehicle of claim 12, wherein the sensor part comprises
a plurality of height sensors that senses the height of the main body part;
a gyro sensor that senses the inclination of the main body part; and
an acceleration sensor that senses pulling due to motion inertia of the main body part.

15. The pulling compensation apparatus for the vehicle of claim 12, wherein the geared motor further comprises
a twist spring provided on one side of the geared motor; and
a partial rotation shaft connecting the twist spring and a pinion gear,
wherein the twist spring transmits the power to the pinion gear, and supports the main body part while reducing the shocks transmitted from the vehicle.

16. The pulling compensation apparatus for the vehicle of claim 12, wherein the geared motor further comprises
an electronic brake provided at a rear end of the geared motor,
wherein the electronic brake prevents the geared motor from being rotated by a load applied to the main body part and the transfer part.
